(19) United States
(12) Patent Application Publication
(10) Pub. No.: US 2012/0126620 A1
(43) Pub. Date: May 24, 2012

(54) METHOD OF SUPPLYING POWER VENT/DIRECT VENT WATER HEATER BACKUP POWER WHEN THE MAIN POWER IS OFF AND THE BACKUP POWER SUPPLY SYSTEM THEREOF

(75) Inventors: Chung-Chin Huang, Taichung (TW); Chin-Ying Huang, Taichung (TW); Hsin-Ming Huang, Taichung (TW); Hsing-Hsiung Huang, Taichung (TW)

(73) Assignee: GRAND MATE CO., LTD., Taichung (TW)

(21) Appl. No.: 12/954,481

(22) Filed: Nov. 24, 2010

(51) Int. Cl. H02J 7/00

(52) U.S. Cl. 307/64

(57) ABSTRACT

A backup power supply system of a water heater includes a power transforming device and a controller. The power transforming device generates a DC current with an initial voltage through sensing the temperature change under a low battery condition. The controller examines the initial voltage of the DC current and gives command to which device to supply power to the water heater or to amplify the initial voltage of the DC current for maintaining the water heater's normal work.

### BACKGROUND OF THE INVENTION

1. Field of the Invention

The present invention relates generally to a water heater, and more particularly to a method of supplying a power vent or a direct vent water heater a backup power when the main power is off and the backup power supply system thereof.

2. Description of the Related Art

A conventional water heater, such as water heater, gas stove or fireplace, burns the gas by discharging. The power for discharging must be a DC power, which is usually obtained from converting an AC power or from a battery. In other words, a stable power supply is very important for the water heater to provide hot water.

In a case of converting the AC power into the DC power, the wires may be broken in situations such as being pulled apart by someone or snapped off by animal, which cuts off the power supply and the water heater doesn't work until the power is recovered again. In winter time, it is cold and everything is covered by snow, which makes it difficult to recover the power when the power for the water heater is off, and thus causes a great deal of inconvenience.

Some water heaters provide a backup battery to supply power when the power is off. Another type of water heater provides the battery for discharging. User only needs to replace a new battery when the power is out. However, the battery has a limited power supply that the battery cannot afford to maintain a water heater equipped with electronic devices and air blower. Batteries need to be replaced frequently and it is very inconvenient when the user can't find the battery.

### SUMMARY OF THE INVENTION

The primary objective of the present invention is to provide a method of supplying backup power to a water heater and a backup power supply system thereof, which transform the heat of the combustor into electrical power to maintain the water heater's work when the battery is in low battery condition.

According to the objective of the present invention, a backup power supply system of a water heater includes a power transforming device and a controller. The power transforming device transforms the heat of a combustor of the water heater into a DC current with an initial voltage. The controller includes an examining unit and a voltage regulator. The examining unit is preset with a reference voltage and a working voltage. The controller gives command to a DC power supply to supply power to the power needed module when the initial voltage is lower than the reference voltage. The controller gives command to the power transforming device to supply the DC current to the power needed module when the initial voltage is higher than or identical to the working voltage. The voltage regulator amplifies the initial voltage into the working voltage to supply the power needed module power when the initial voltage is between the reference voltage and the working voltage.

The method of supplying a backup power including the following steps: Providing a hot junction and a cold junction to sense temperatures. Generating a DC current with an initial voltage when a temperature sensed by the hot junction is higher than a temperature sensed by the cold junction, and then examining the initial voltage of the DC current.

A controller gives command to a DC power supply to supply power to the power needed module when the initial voltage is lower than the reference voltage.

The controller supplies the DC current to the power needed module when the initial voltage is higher than or identical to the working voltage; and

The controller amplifies the initial voltage into the working voltage to supply the power needed module power when the initial voltage is between the reference voltage and the working voltage.

### BRIEF DESCRIPTION OF THE DRAWINGS

FIG. 1 is a front view of the water heater of a first preferred embodiment of the present invention;

FIG. 2 is a left view of the water heater of the first preferred embodiment of the present invention;

FIG. 3 is a sketch diagram of the thermo-electric cooling chip of the first preferred embodiment of the present invention in the closed condition;

FIG. 4 is a flow chart of supplying the backup power of the first preferred embodiment of the present invention;

FIG. 5 is a left view of the water heater of a second preferred embodiment of the present invention equipped with the thermocouple; and

FIG. 6 shows the closed loop of the thermocouple.

### DETAILED DESCRIPTION OF THE INVENTION

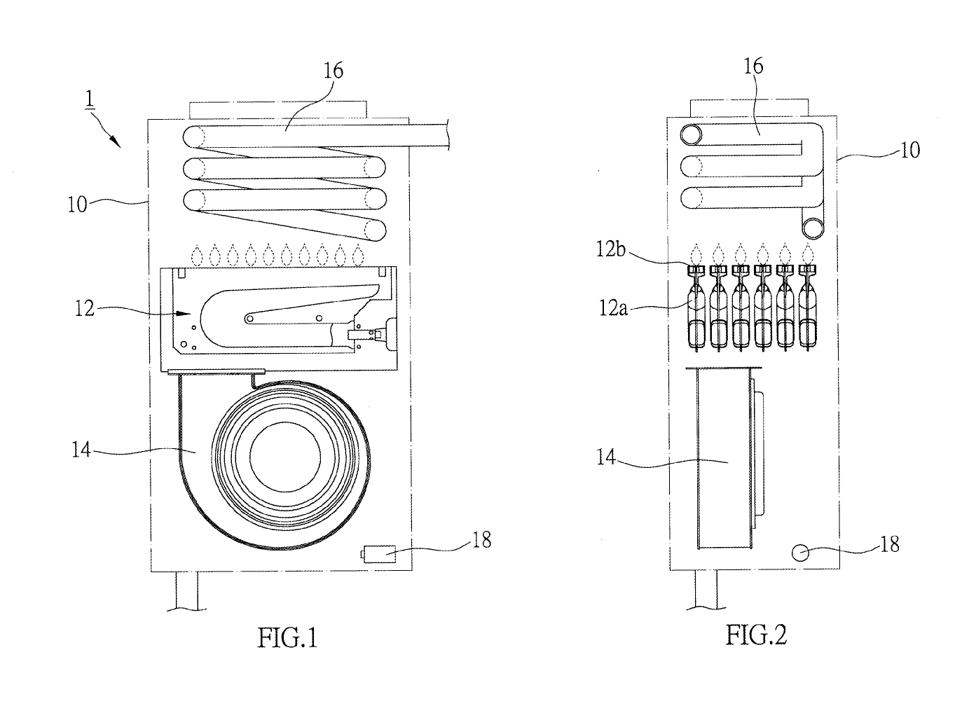

The first preferred embodiment of the present invention provides a water heater 1, as shown in FIGS. From FIG. 1 to FIG. 4, includes a case 10, a combustor 12, a blower 14, a water pipe 16, a DC power supply 18, a power transforming device 20, and a controller 22.

The combustor 12 includes a plurality of burners 12a arranged side-by-side in the case 10. The combustor 12 is above the blower 14, and the water pipe 16 is above the combustor 12. The combustor 12 has several openings for flame 12b at a top thereof to produce flames and heat up the water pipe 16. The water pipe 16 has a cold water section 16a and a hot water section 16b. The blower 14 forces air to flow into the combustor 12 to be mixed with gas before burning.

The DC power supply 18 is a battery mounted on a bottom of the case 10 in the present embodiment. The battery 18 supplies power to an ignition device 12c of the combustor 12, the blower 14, a screen 24, and other electronic devices 26. Hereafter, we call the blower 14, the screen 24, and the electronic devices 26 a “power needed module” 28. It is noted that, in the water heater 1, AC power is a main power to activate the power needed module 28 in normal conditions, and the battery is a backup power to supply power to the power needed module 28 when the main power is off.

The power transforming device 20 is a thermoelectric cooling chip in the present embodiment having a plurality of N type semiconductors 20a and P type semiconductors 20b to form a closed loop 21. The closed loop 21 includes a hot junction P1 close to the hot water section 16b of the water pipe 16 and a cold junction P2 close to the cold water section 16a of the water pipe 16. In practice, the thermoelectric cooling chip may generate a voltage when it is operated reversely. For this condition, it is called thermoelectric power generating module.

The controller 22 is electrically connected to the thermoelectric cooling chip 20 and has an examining unit 22a and a voltage regulator 22b. The examining unit 22 has a logic circuit 22c, in which a reference voltage V₁ and a working voltage V₂ are stored. The working voltage V₂ is a minimum voltage to activate the power needed module 28. In the present invention, the reference voltage V₁ is 300 mV and the working voltage V₂ is 6V. These voltages can be any value according to the exact condition of the water heater.

A control method of providing the backup power via the thermoelectric cooling chip 20 and the controller 22 when the main power is off and the battery 18 is in a low-battery condition is described hereunder:

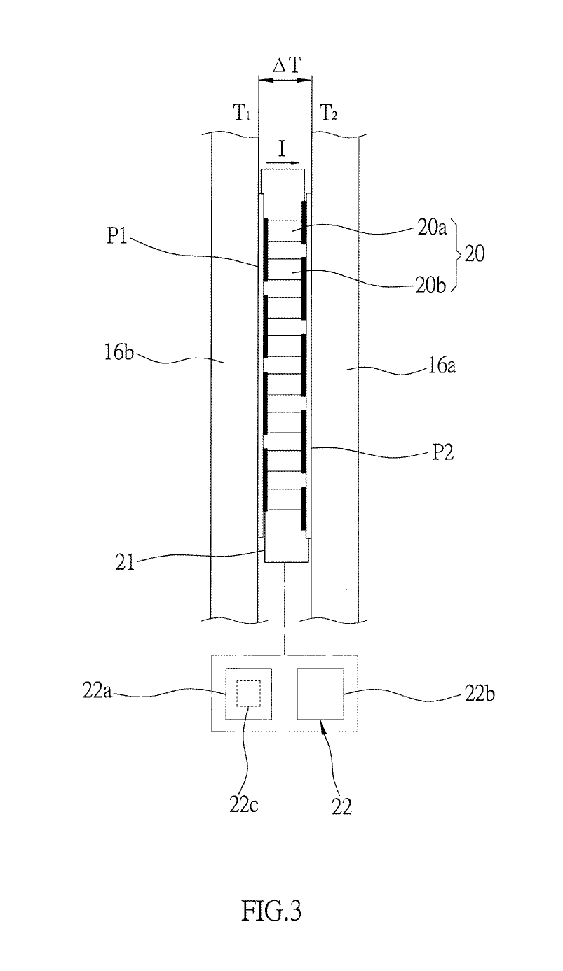

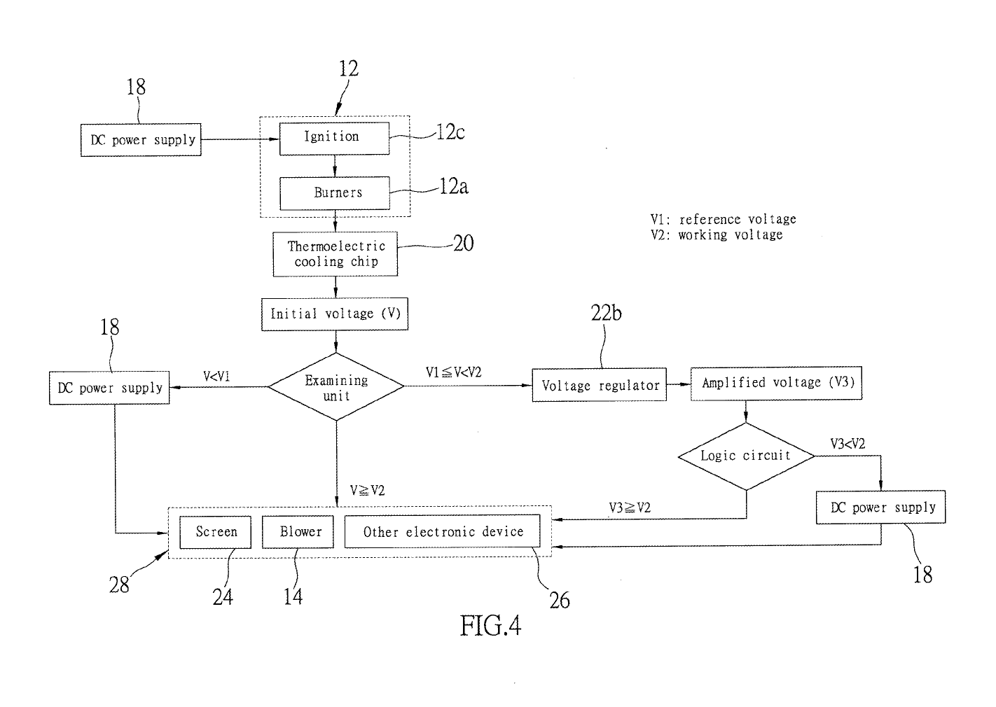

As shown in FIG. 3 and FIG. 4, the battery 18 supplies the combustor 12 power for ignition. At this time, the thermoelectric cooling chip 20 senses a first temperatures T₁ of the cold water section 16a and a second temperature T₂ of the hot water section 16b through the hot junction P1 and the cold junction P2 to provide a DC current I with an initial voltage V. The controller will take different actions according to a temperature difference ΔT of the first temperatures T₁ and the second temperature T₂ (ΔT=T₁−T₂).

In a condition of the temperature difference ΔT (ΔT=T₁−T₂) being less than a minimum difference (20° C. in the present invention), it means that the initial voltage V is greater than the reference voltage V₁ (300 mV). At this time, the controller 22 commands that the battery 18 supply power to the power needed module 28. The battery 18 will soon run out, which will reach another condition described hereafter. This condition rarely happens because the reference voltage V₁ is set low.

In a condition of the temperature difference ΔT (ΔT=T₁−T₂) being identical to or greater than a maximum difference (90° C. in the present invention), it means the initial voltage V is greater than the working voltage V₂ (6V). At this time, the thermoelectric cooling chip 20 transforms the thermal energy into electric power to provide the power needed module 28 a DC current I directly that the blower 14, the screen 24 and the electronic devices work by the DC current I rather than the power of the battery 18.

In a condition of the temperature difference ΔT (ΔT=T₁−T₂) being in a range between the minimum difference and the maximum difference (20° C. and 90° C.), it means that the initial voltage V is between 300 mV and 6V. At this time, the controller 22 activates the voltage regulator 22b to amplify the voltage to have an amplified voltage V₃. In the present embodiment, the voltage regulator 22b amplifies the voltage 20 times. However, the voltage regulator 22b may amplify the voltage to any value according to the exact need. After that, the controller 22 activates the logic circuit 22c of the examining unit 22a to examine the amplified voltage V₃ to demand that thermoelectric cooling chip 20 provide power when the amplified voltage V₃ is greater than 6V or to demand that the battery 18 provide power when the amplified voltage V₃ is less than 6V.

In conclusion, the present invention provides the power transforming device a method to transform thermal energy into electric power and lowers the barrier of amplifying the voltage to provide the power needed module sufficient power by amplifying the voltage in a specific condition. The present invention may maintain the water heater's normal work even when the AC power supply is off.

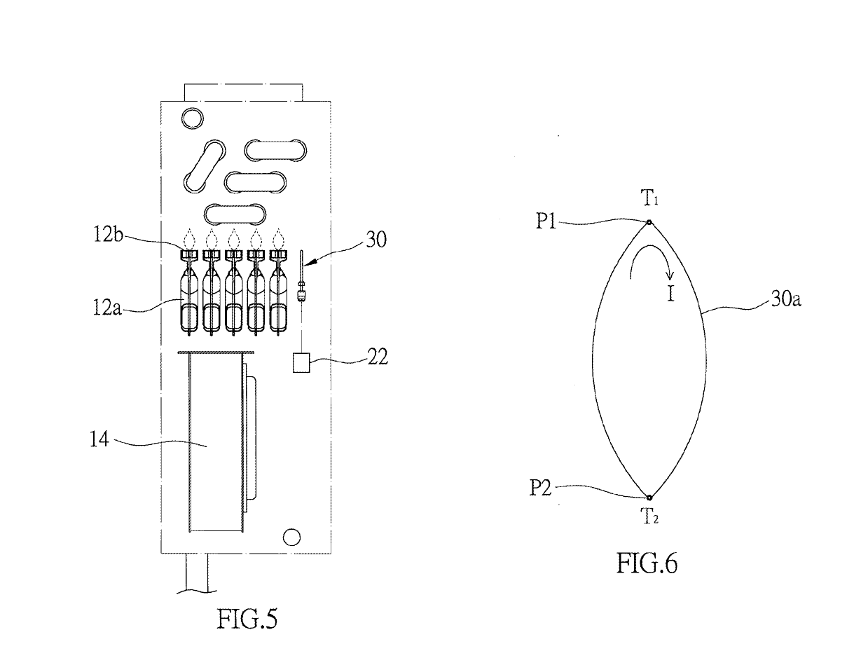

FIG. 5 and FIG. 6 show the second preferred embodiment of the present invention, in which the power transforming device is a thermocouple 30. The thermocouple 30 is electrically connected to the controller 22. The thermocouple 30 has two different conductive materials to form a closed loop 30a. The closed loop 30a has a hot junction P1 to sense a first temperature T₁ and a cold junction P2 to sense a second temperature T₂. The hot junction P1 is arranged at a position close to the openings for flame 12b of the burners 12a. The closed loop 30a generates a DC current I with an initial voltage V when the first temperature T₁ is greater than the second temperature T₂. The controller 22 of the second preferred embodiment does the same procedures as the first preferred embodiment according to the initial voltage V to maintain the water heater's work.

The description above is a few preferred embodiments of the present invention and the equivalence of the present invention is still in the scope of claim construction of the present invention.

What is claimed is:

1. A backup power supply system of a water heater, in which the water heater includes a DC power supply to provide a combustor power and a power needed module, comprising:
a power transforming device for transforming a thermal energy generated by the combustor into a DC current with an initial voltage; and
a controller, which is electrically connected to the power transforming device, including an examining unit and a voltage regulator, wherein the examining unit is stored with a reference voltage and a working voltage therein that the controller gives command to the DC power supply to supply the power needed module power when the initial voltage is less than the reference voltage and gives command to the power transforming device to provide the DC current to the power needed module when the initial voltage is identical to or greater than the reference voltage and gives command to the voltage regulator to amplify the initial voltage into the working voltage and then gives command to the power transforming device to provide the DC current to the power needed module when the initial voltage is in a range between the reference voltage and the working voltage.

2. The backup power supply system as defined in claim 1, wherein the power transforming device includes a hot junction to sense a first temperature and a cold junction to sense a second temperature to generate the DC current when the first temperature is greater than the second temperature.

3. The backup power supply system as defined in claim 2, wherein the initial voltage is calculated by a temperature difference of the first temperature and the second temperature, wherein it indicates that the initial voltage is less than the reference voltage when the temperature difference is less than a minimum difference; it indicates that the initial voltage is greater than the working voltage when the temperature difference is less than a maximum difference, and it indicates that the initial voltage is between the reference temperature and the working voltage when the temperature difference is in a range between the minimum difference and the maximum difference.

4. The backup power supply system as defined in claim 3, wherein the minimum difference is 20° C., and the maximum difference is 90° C.

5. The backup power supply system as defined in claim 3, wherein the reference voltage is 300 mV, and the working voltage is 6V.

6. The backup power supply system as defined in claim 1, wherein the examining unit of the controller further includes a logic circuit to examine an amplified voltage, which is the initial voltage amplified by the voltage regulator, and the controller gives command to the power transforming device to provide the DC current to the power needed module when the amplified voltage is greater than or identical to the working voltage, and the controller gives command to the DC power supply to provide the power needed module power when the amplified voltage is less than the working voltage.

7. The backup power supply system as defined in claim 2, wherein the water heater further includes a water pipe with a hot section and a cold section, and the power transforming device has a thermoelectric cooling chip with the hot junction and the cold junction, and the hot junction of the thermoelectric cooling chip is closed to the hot section of the water pipe and the cold junction of the thermoelectric cooling chip is closed to the cold section of the water pipe.

8. The backup power supply system as defined in claim 2, wherein the power transforming device has a thermocouple with the hot junction and the cold junction, and the hot junction of the thermocouple is close to openings for flames of the combustor.

9. The backup power supply system as defined in claim 1, wherein the DC power supply is a battery.

10. The backup power supply system as defined in claim 1, wherein the power needed module includes a blower.

11. A method of supplying a backup power to a water heater, wherein the water heater includes a combustor, a DC power supply supplying the combustor power for ignition, and a power needed module, comprising the steps of:
providing a hot junction located at a high temperature position and a cold junction located at a low temperature position
generating a DC current with an initial voltage, wherein a temperature at the high temperature position is greater than a temperature at the low temperature position;
providing a controller to examine the initial voltage of the DC current, wherein
the controller giving command to the DC power supply to supply power to the power needed module when the initial voltage is less than a reference voltage;
the controller supplying power to the power needed module when the initial voltage is greater than a working voltage; and
the controller amplifying the initial voltage into the working voltage and then providing the DC current to the power needed module when the initial voltage is in a range between the reference voltage and the working voltage.

12. The method as defined in claim 11, wherein the initial voltage is calculated by a temperature difference of the first temperature and the second temperature, wherein it indicates that the initial voltage is less than the reference voltage when the temperature difference is less than a minimum difference, it indicates that the initial voltage is greater than the working voltage when the temperature difference is less than a maximum difference, and it indicates that the initial voltage is between the reference temperature and the working voltage when the temperature difference is in a range between the minimum difference and the maximum difference.

13. The method as defined in claim 12, wherein the controller includes a logic circuit to examine an amplified voltage, which is the initial voltage amplified by the controller, and the controller gives command to the power transforming device to provide the DC current to the power needed module when the amplified voltage is greater than or identical to the working voltage, and the controller gives command to the DC power supply to provide the power needed module power when the amplified voltage is less than the working voltage.

14. The method as defined in claim 12, wherein the minimum difference is 20° C., and the maximum difference is 90° C.

15. The method as defined in claim 12, wherein the reference voltage is 300 mV, and the working voltage is 6V.
